(19) United States
(12) Patent Application Publication
(10) Pub. No.: US 2020/0367698 A1
(43) Pub. Date: Nov. 26, 2020

(54) FOAM SUPPLY DEVICE

(71) Applicant: MORITA HOLDINGS CORPORATION, Osaka-shi, Osaka (JP)

(72) Inventor: Yoshitoshi MATSUSHIMA, Iga-shi (JP)

(73) Assignee: MORITA HOLDINGS CORPORATION, Osaka-shi, Osaka (JP)

(21) Appl. No.: 16/769,668

(22) PCT Filed: Nov. 20, 2018
(86) PCT No.: PCT/JP2018/042835

§ 371 Date: Jun. 4, 2020

(30) Foreign Application Priority Data
Dec. 14, 2017 (JP) 2017-239808

(51) Int. Cl. A47K 3/28; B01F 15/02; B01F 3/04; E03C 1/046

(52) U.S. Cl. CPC A47K 3/281; B01F 15/0202; E03C 1/046; B01F 3/04099; B01F 3/04021

(57) ABSTRACT

The present invention provides a foam supply device in which water is not stirred in a chassis and therefore, resistance in the water pipe can be reduced, and foam can stably be radiated without deteriorating momentum of radiation.

The foam supply device includes a water supply port 11, a water pipe 13 for introducing water from the water supply port 11, a drug supply pipe 14, a drug supply section 15, a gas supply pipe 17, a gas mixing section 19, a stirring section 60, a water pipe discharge port 12 and a radiation pipe 40. The water supply port 11 and the water pipe discharge port 12 are provided in the chassis 10. The water pipe 13, the drug supply pipe 14 and the drug supply section 15 are placed in the chassis 10. The stirring section 60 is placed downstream from the water pipe discharge port 12. Water which is not stirred by a stirring section 60 flows through the water pipe 13 placed in the chassis 10.

### TECHNICAL FIELD

The present invention relates to a foam supply device used when washing a human body and the like.

### BACKGROUND TECHNIQUE

When a human body is washed using detergent such as a soap, a method of directly applying detergent to the human body and scrubbing the body or a method of foaming detergent and scrubbing the body by means of a towel or a sponge is employed. These washing or cleaning procedures wash out a stain of a body surface, wash out oil content of skin, and reduce an amount of skin oil. For this reason, when washing a human body, it is necessary that detergent is sufficiently foamed by a towel or a sponge to wash the body in a gentle fashion without excessively scrubbing the body while utilizing an elastic force of the foam so that excessive reduction of the amount of skin oil is suppressed or avoided.

Particularly in the case of elderly people, since recovering speed of the amount of skin oil after washing his or her body is slow, a dry state of skin is continued for a long time and itchy skin is prone to be induced, and there is a possibility that skin trouble is caused. On the other hand, in the case of nursing-care services for elderly people, since bathing care of twenty or more people is conducted over a short time in some cases, it takes a lot of time and labor to sufficiently foam detergent.

Patent document 1 proposes a foam supply device for washing a human body in which by optimally setting a foaming ratio of foam and by producing homogeneous foam, a feeling of satisfaction of “washing” can be obtained while reducing a bather's trouble caused by “excessive scrubbing or excessive washing”, burden on a body of a caregiver can be reduced, retentivity (adhesiveness) is excellent, feel of material of the foam is also excellent, and the foam can swiftly be applied.

The patent document 1 also discloses that washing by means of foam and washing out by means of water can be carried out from one radiation port.

### PRIOR ART DOCUMENT

### Patent Document

[Patent Document 1] Japanese Patent Application Laid-open No. 2015-47236

### SUMMARY OF THE INVENTION

### Problem to be Solved by the Invention

However, a main purpose of the foam supply device for washing a human body of the patent document 1 is to sufficiently generate homogeneous foam, and the patent document 1 does not disclose miniaturization of the device or improvement of usability.

When drug such as detergent and gas are mixed into water to wash a human body by means of foam as in the patent document 1, texture or a grained degree of the foam becomes finely by stirring the drug, the gas and the water. There is a problem that since resistance in a pipe is increased, it takes time until foam radiation is stabilized when the washing operation is switched to foam washing after water is used, and since momentum of the radiation is deteriorated, a lump of foam drops from the radiation port if a shower hose is long.

It is an object of the present invention to provide a foam supply device in which since water mixed with gas and drug is not stirred in a chassis, resistance in a water pipe can be reduced, foam can stably be radiated without deteriorating momentum of radiation (spray), and since a stirring section is not placed in the chassis, the chassis can be made small.

### Means for Solving the Problem

A foam supply device of the invention described in claim 1 including: a water supply port 11 for supplying water from a water supply source; a water pipe 13 for introducing the water from the water supply port 11; a drug supply pipe 14 for supplying drug; a drug supply section 15 for connecting the drug supply pipe 14 to the water pipe 13 to supply the drug to the water; a gas supply pipe 17 for supplying gas from a gas supply section 30; a gas mixing section 19 for connecting the gas supply pipe 17 to the water pipe 13 to mix the gas in the water; a stirring section 60 for stirring the gas and the drug which is supplied to the water; a water pipe discharge port 12 for discharging the water mixed with at least the drug; and a radiation pipe 40 having one end connected to the water pipe discharge port 12 and the other end connected to a radiation port 41 which radiates the water, the drug and the gas stirred by the stirring section 60, in which the chassis 10 includes the water supply port 11 and the water pipe discharge port 12, the water pipe 13, the drug supply pipe 14 and the drug supply section 15 are placed in the chassis 10, wherein the stirring section 60 is placed downstream from the water pipe discharge port 12, and the water which is not stirred by the stirring section 60 flows through the water pipe 13 placed in the chassis 10.

According to the invention described in claim 2, in the foam supply device described in claim 1, the gas mixing section 19 is placed downstream from the water pipe discharge port 12, and the water which is not mixed with the gas flows through the water pipe 13 placed in the chassis 10.

According to the invention described in claim 3, the foam supply device described in claim 2 further includes a switching valve 50 which selectively switches between the water mixed with the drug and the gas and the water which is not mixed with the drug and the gas, and introduces the selectively switched one of them into the radiation pipe 40, wherein the switching valve 50 is placed downstream from the water pipe discharge port 12, and the gas mixing section 19 is placed upstream from the switching valve 50.

According to the invention described in claim 4, in the foam supply device described in claim 3, the switching valve 50 is fixed to the tap water pipe.

According to the invention described in claim 5, the foam supply device described in any one of claims 1 to 4 further includes an auxiliary stirring section 62 having stirring performance which is lower than that of the stirring section 60, wherein the stirring section 60 and the auxiliary stirring section 62 are placed between the gas mixing section 19 and the radiation port 41, and the auxiliary stirring section 62 is placed upstream from the stirring section 60.

According to the invention described in claim 6, in the foam supply device described in any one of claims 1 to 5, the stirring section 60 is placed between the radiation port 41 and the other end of the radiation pipe 40.

### Effect of the Invention

According to the foam supply device of the present invention, since water is not stirred in a chassis, resistance in a water pipe can be reduced, foam can stably be radiated without deteriorating momentum of radiation, and since a stirring section is not placed in the chassis, the chassis can be made small.

### BRIEF DESCRIPTION OF THE DRAWINGS

FIG. 1 is a piping system diagram of a foam supply device according to a first embodiment of the present invention;

FIG. 2 is a diagram showing stabilizing time of foam radiation when an installation position and stirring performance of a stirring section of the foam supply device are changed;

FIG. 3 is a piping system diagram of a foam supply device according to a second embodiment of the invention;

FIG. 4 is a piping system diagram of a foam supply device according to a third embodiment of the invention;

FIG. 5 is a piping system diagram of a foam supply device according to a fourth embodiment of the invention; and

FIG. 6 is a piping system diagram of a foam supply device according to a fifth embodiment of the invention;

### MODE FOR CARRYING OUT THE INVENTION

According to a foam supply device of a first embodiment of the present invention, a stirring section is placed on a downstream side of a water pipe discharge port, water mixed with drug which is not stirred with gas by a stirring section flows through a water pipe placed in a chassis.

According to the first embodiment, since water mixed with gas and drug is not stirred in the chassis, resistance in the pipe can be reduced, foam can be radiated stably without deteriorating momentum of the radiation, and since the stirring section is not placed in the chassis, the chassis can be made small.

According to a second embodiment of the invention, in the foam supply device of the first embodiment, a gas mixing section is placed downstream from the water pipe discharge port, and the water which is not mixed with gas flows through the water pipe placed in the chassis.

According to the second embodiment, since gas is not mixed in the chassis, resistance in the water pipe can be reduced, foam can be radiated stably without deteriorating momentum of the radiation, and since the stirring section and the gas mixing section are not placed in the chassis, the chassis can be made small.

According to a third embodiment of the invention, the foam supply device of the second embodiment further includes a switching valve which selectively switches between water mixed with drug and gas and water which is not mixed with drug and gas, and introduces selectively switched one of them into the radiation pipe, the switching valve is placed downstream from the water pipe discharge port, and the gas mixing section is placed upstream from the switching valve.

According to the third embodiment, by providing the switching valve, it is possible to radiate water and foam by one radiation port as required by a user, and since the switching valve is not placed in the chassis, the chassis can be made small.

According to a fourth embodiment of the invention, in the foam supply device of the third embodiment, the switching valve is fixed to the tap water pipe.

According to the fourth embodiment, since a force from the radiation pipe is not directly applied to the chassis, it is unnecessary to strongly fix the chassis, and it is unnecessary to enhance the strength of the chassis.

According to a fifth embodiment of the invention, the foam supply device of any one of the first to fourth embodiments further includes an auxiliary stirring section having stirring performance which is lower than that of the stirring section, wherein the stirring section and the auxiliary stirring section are placed between the gas mixing section and the radiation port, and the auxiliary stirring section is placed upstream from the stirring section.

According to the fifth embodiment, by placing the auxiliary stirring section in a flow path from the gas supply section to the stirring section, gas and liquid do not separately flow until they reach the stirring section. Therefore, it is possible to prevent intermittent radiation which is a phenomenon that the gas and the liquid do not become foam and they are radiated alternately.

Further, according to this embodiment, since stirring performance of the auxiliary stirring section is lower than that of the stirring section, the auxiliary stirring section can be made smaller than the stirring section, and it is possible to save space around the switching valve. Further, according to this embodiment, as the stirring operation of the gas and the liquid is progressed, resistance of fluid is increased. Therefore, if the auxiliary stirring section is used, pressure loss caused by the resistance of the radiation pipe is suppressed as compared with a case where a stirring section having sufficient stirring performance is provided on an upstream side of the radiation pipe. Therefore, radiation momentum of foam is less prone to be deteriorated even of the radiation pipe is made long.

According to a sixth embodiment of the invention, in the foam supply device of any one of the first to fifth embodiments, the stirring section is placed between the radiation port and the other end of the radiation pipe.

According to the sixth embodiment, not only resistance of the water pipe but also resistance of the radiation pipe can be reduced, and it is possible to stably radiate foam without deteriorating the momentum of the radiation. According to this embodiment, the stirring section on the side of the radiation port can be formed integrally with the radiation port.

### Embodiments

A foam supply device according to a first embodiment of the present invention will be described below.

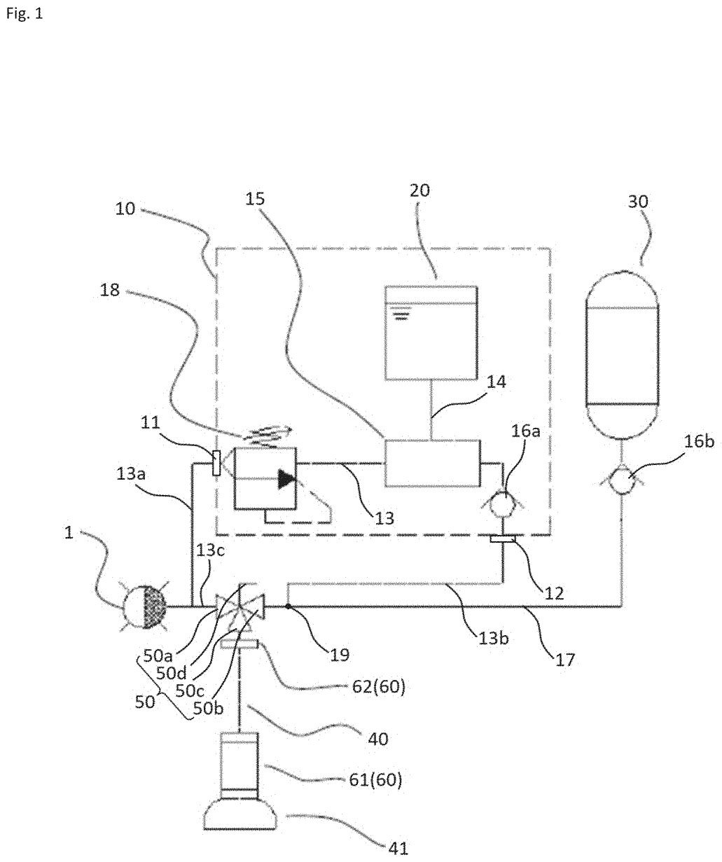

FIG. 1 is a piping system diagram of the foam supply device of the first embodiment.

The foam supply device of the first embodiment includes a chassis 10, a drug storage tank 20 in which liquid drug is stored, a gas supply section 30 for supplying gas, and a radiation pipe 40. The gas supply section 30 is a compressor or a pressure cylinder for example. Air is used as the gas, but oxygen, carbon dioxide, nitrogen, hydrogen, ozone, helium and argon may be used only if they are gaseous matters.

The chassis 10 includes a water supply port 11 for supplying water (hot water or cold water) from a faucet 1 which becomes a water supply source of a tap water pipe or a water storage tank. The chassis 10 also includes a water pipe discharge port 12 through which water mixed with at least drug is discharged. Placed in the chassis 10 are a water pipe 13 for introducing water from the water supply port 11, a drug supply pipe 14 for supplying drug of the drug storage tank 20, and a drug supply section 15 for connecting the drug supply pipe 14 to the water pipe 13 and supplying drug to water.

A material having surfactant as a major component agitation section the drug, but protein or saponin may also be used only if it is expandable liquid mixed with water. An aspirator which utilizes negative pressure generated through the use of Venturi effect is used agitation section the drug supply section 15 for example, but an electric pump or a water driving pump which utilizes flow of water may also be used.

It is preferable that a water check valve 16a and a water regulator 18 maintains constant water pressure are provided in the chassis 10.

The water pipe 13 connects the water supply port 11 and the water pipe discharge port 12 to each other. The water pipe 13 includes the drug supply section 15. The drug supply section 15 is located between the water supply port 11 and the water pipe discharge port 12. The water pipe 13 located between the water supply port 11 and the drug supply section 15 includes the water regulator 18. The water pipe 13 located between the drug supply section 15 and the water pipe discharge port 12 includes the water check valve 16a. An introduction water pipe 13a is connected to the water supply port 11, and water from the faucet 1 is introduced into the chassis 10 from the introduction water pipe 13a. A deriving water pipe 13b is connected to the water pipe discharge port 12. Water to which drug is supplied in the chassis 10 is derived from the deriving water pipe 13b to a location outside the chassis 10.

The drug supply pipe 14 is connected to the drug supply section 15.

The drug storage tank 20 may be placed in the chassis 10, but it is preferable that the drug storage tank 20 is detachably attached to the chassis 10.

An electric driving compressor is used as the gas supply section 30, but a compression cylinder or a water driving compressor may also be used. To make a supply amount of gas constant, it is preferable that a pressure adjustor or a wringer is also used in the discharge port of the gas supply section 30. The gas supply section 30 is placed separately from the chassis 10. A gas supply pipe 17 is connected to the gas supply section 30. The gas supply pipe 17 includes a gas check valve 16b.

A switching valve 50 is connected to one end of the radiation pipe 40, and a radiation port 41 is connected to the other end of the radiation pipe 40. A shower hose is utilized as the radiation pipe 40, but if fluid can be transported, the following tube or pipe can also be used. That is, a deformable hollow thin and long tube, or a rigid pipe having a circular or polygonal cross section. In the latter case, universal joints having flow paths are connected to both ends of the rigid pipe. A three-way valve is used as the switching valve 50, but it is also possible to use an electric switching valve which electrically switches between flow paths, or a timing type switching valve which is usually connected to a radiation flow path of only water but which is automatically returned to radiation of only water for constant time after the radiation is switched to foam radiation.

A shower head of a surface having a plurality of holes through which foam is radially radiated is used as the radiation port 41. Alternatively, it is also possible to use a radiator provided at its thin and long pipe with a plurality of holes, or a radiation port having one port such as an end of a hose. When pressure of a water supply source is varied like a tap water pipe for example, if a water regulator is used, it is possible to stably radiate foam.

A water pipe 13c which is branched off from the introduction water pipe 13a is connected to one introduction port 50a of the switching valve 50, and the deriving water pipe 13b is connected to the other introduction port 50b of the switching valve 50. Therefore, water which is not mixed with drug and gas is supplied to the one introduction port 50a of the switching valve 50, and water mixed with drug and gas is supplied to the other introduction port 50b of the switching valve 50. The radiation pipe 40 is connected to a deriving port 50c of the switching valve 50. The deriving water pipe 13b connects the water pipe discharge port 12 and the switching valve 50 to each other, and includes a gas mixing section 19. The gas mixing section 19 connects the gas supply pipe 17 to the deriving water pipe 13b, and mixes gas into water.

The radiation pipe 40 includes a stirring section 60 which stirs water, drug and gas. The stirring section 60 is of a net or mesh type in which a flow path in the stirring section 60 is enlarged and nets are placed in the enlarged inside of the stirring section 60. The nets used here are so-called nets which are weaved from a wire or a thread, but it is also possible to use a net material having one plate provided with a plurality of holes, its material may be metal such as stainless steel or resin, and a material which is not corroded or deteriorated by drug is used. The number of the nets are one or more, and if only one stirring section 60 is provided, it is preferable to provide ten or more nets.

Instead of the net type stirring section 60, it is also possible to employ the following structures. That is, it is possible to employ a static mixer in which a plurality of guide blades are alternately placed in a flow path, a plurality of plates having holes of different patterns are placed in the flow path at intervals, a brush is placed in the flow path to stir fluid. It is also possible to employ a mixer in which a blade or a brush is rotated by water or electric power to stir, a vortex generator in which a projection is provided in a flow path to generate vertical vortex, and a system in which a flow path is locally narrowed to promote turbulence flow to stir. Flow of water mixed with drug and gas is disturbed and they are stirred when they pass through the stirring section 60. According to this, they are uniformly dispersed and mixed with each other and become quality foam, and the foam is supplied to the radiation port 41. The radiation port 41 discharges foam radially.

The stirring section 60 of this embodiment also includes, in addition to a stirring section 61, an auxiliary stirring section 62 having stirring performance lower than that of the stirring section 61. If net bodies having holes are used as a stirring member, nine net bodies used for the stirring section 61 and one net body used for the auxiliary stirring section 62 are used.

The stirring section 61 and the auxiliary stirring section 62 are placed between the gas mixing section 19 and the radiation port 41. The auxiliary stirring section 62 is placed on an upstream end of the radiation pipe 40, the stirring section 61 is placed on a downstream end of the radiation pipe 40, and the auxiliary stirring section 62 is placed upstream from the stirring section 61.

The switching valve 50 includes a lever 50d for switching between the one introduction port 50a and the other introduction port 50b. Therefore, by operating the lever 50d, the switching valve 50 selectively switches between “water mixed with drug and gas” and “water which is not mixed with drug and gas”, and derives the same from the deriving port 50c to the radiation pipe 40.

The other introduction port 50b is brought into communication with the deriving port 50c by the lever 50d, thereby radiating foam.

When foam is radiated, pressure of water introduced from the water supply port 11 into the chassis 10 is adjusted by the water regulator 18 into a constant value. Thereafter, drug is supplied to the water by the drug supply section 15, and the water is derived from the water pipe discharge port 12 to a location outside the chassis 10. Water which is to the location outside the chassis 10 flows through the introduction water pipe 13a, gas is mixed into the water by the gas mixing section 19 and thereafter, the mixture is introduced into the radiation pipe 40. The water mixed with drug and gas introduced into the radiation pipe 40 are stirred by the stirring section 60, they are uniformly dispersed and mixed with each other and become quality foam, and they are discharged from the radiation port 41.

The one introduction port 50a is brought into communication with the deriving port 50c by the lever 50d, thereby radiating water.

When water is radiated, water supplied from the water pipe 13c is introduced from the deriving port 50c into the radiation pipe 40.

By providing the switching valve 50 in this manner, it is possible to selectively discharge the foam radiation and water radiation from the radiation port 41.

Further, by providing the stirring section 60 downstream from the switching valve 50, it is possible to wash out foam which remains in the stirring section 60 after the foam radiation by means of water at the time of the water radiation. According to this, it is possible to prevent drug from solidifying and clogging the net bodies of the stirring section 60.

The water regulator 18 makes, constant, water pressure applied to the drug supply section 15 at the time of the foam radiation. Especially when tap water is supplied to the water pipe 13, pressure of tap water is largely varied depending upon installation environment, surrounding usage conditions of tap water and the like, but when the aspirator is used and the drug supply section 15, it is possible to stably suck drug even if the pressure of tap water is varied.

When the radiation port 41 is a shower head, nets are inserted into a space of a handle of the shower head to form the stirring section 61. According to this, it is possible to save space of the entire configured device. If the radiation port 41 is provided with a stirring section 61 having high stirring performance, it is possible to shorten the time which is required for switching from the water radiation to the foam radiation. If a stirring section 61 having sufficient stirring performance is used at the upstream of the radiation pipe 40, relatively small neat foam having relatively high viscosity and large resistance flows through the radiation pipe 40, but if a stirring section 61 having sufficient stirring performance is used at the downstream of the radiation pipe 40, relatively large foam having relatively low viscosity and small resistance flows through the radiation pipe 40. Therefore, after the water radiation is switched to the foam radiation by the switching valve 50, time required until foam is radiated from the radiation port 41 becomes short.

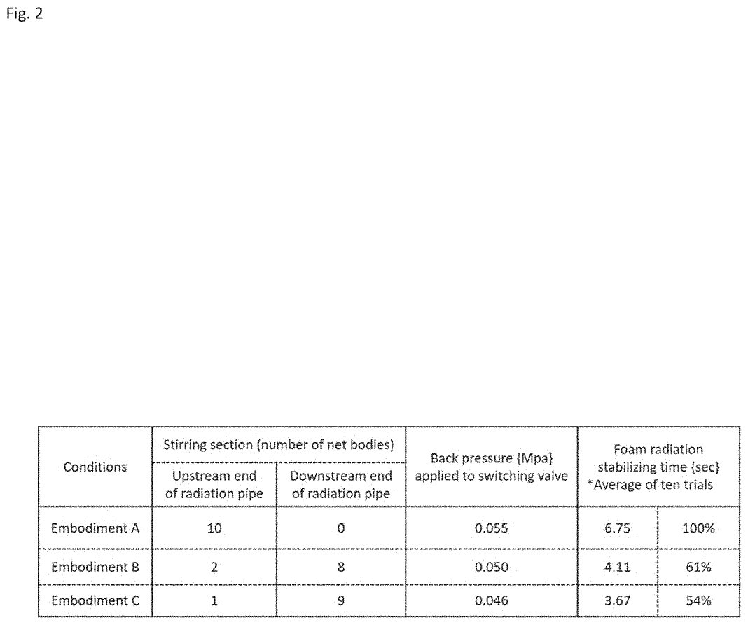

FIG. 2 shows stabilizing time of foam radiation when an installation position and stirring performance of the stirring section are changed using the foam supply device according to the first embodiment.

In an embodiment A, a stirring section 60 having ten net bodies is placed only an upstream end of a radiation pipe 40. In an embodiment B, an auxiliary stirring section 62 having two net bodies is placed on an upstream end of a radiation pipe 40, and a stirring section 61 having eight net bodies is placed on a downstream end of the radiation pipe 40. In an embodiment C, an auxiliary stirring section 62 having one net body is placed on an upstream end of a radiation pipe 40, and a stirring section 61 having nine net bodies is placed on a downstream end of the radiation pipe 40.

Back pressure applied to the switching valve 50 is pressure which is required for radiating foam from the radiation port 41, and stabilizing time of foam radiation is time which is required until the foam radiation is stabilized after water radiation is switched to foam radiation.

As shown in FIG. 2, in the embodiment C, back pressure required for foam radiation is reduced by more than 15% as compared with the embodiment A and stabilizing time of foam radiation is reduced to 54%.

On the other hand, when the water supply source is a tap water port, it is preferable that the introduction water pipe 13a for supplying water from the faucet 1 to the water supply port 11 and the water pipe 13c connected to the switching valve 50 are branched from each other through a cheese, and the switching valve 50 is connected to the faucet 1 through the cheese. According to this, since the switching valve 50 is connected directly to the faucet 1 through the cheese, even if the radiation port 41 is pulled, a force is not transmitted to the chassis 10 through the radiation pipe 40. Therefore, there is not a threat of an external force applied to the chassis 10, and it is unnecessary to take, into account, strength of the chassis 10 and a fixing operation to install the chassis 10.

In the foam supply device of the first embodiment, the stirring section 60 is placed downstream from the water pipe discharge port 12, and water which is not stirred by the stirring section 60 flows through the water pipe 13 placed in the chassis 10. Therefore, since water mixed with gas and drug is not stirred in the chassis 10, it is possible to eliminate a gain of resistance which is caused because foam becomes fine and a gain of fluid resistance which is caused because the stirring section 60 passes. Therefore, it is possible to reduce the resistance in the water pipe 13, and foam can stably be radiated without deteriorating momentum of radiation. Since the stirring section 60 is not placed in the chassis 10, the chassis 10 can be made small.

Further, according to the foam supply device of the first embodiment, the gas mixing section 19 is placed downstream from the water pipe discharge port 12, and water which is not mixed with gas flows through the water pipe 13 placed in the chassis 10. Therefore, in the chassis 10, since gas is not mixed, resistance in the water pipe 13 can be reduced. Foam can stably be radiated without deteriorating momentum of radiation, and since the stirring section 60 and the gas mixing section 19 are not placed in the chassis 10, the chassis 10 can be made small.

In the foam supply device of the first embodiment, the switching valve 50 selectively switches between “water mixed with drug and gas” and “water which is not mixed with drug and gas”, and introduces the selectively switched one of them into the radiation pipe 40, the switching valve 50 is placed downstream from the water pipe discharge port 12, and the gas mixing section 19 is placed upstream from the switching valve 50. Therefore, water can be radiated and foam can be radiated through one radiation port 41 as required by a user, and since the switching valve 50 is not placed in the chassis 10, the chassis 10 can be made small.

The foam supply device of the first embodiment includes the auxiliary stirring section 62 having stirring performance which is lower than that of the stirring section 61, the stirring section 61 and the auxiliary stirring section 62 are placed between the gas mixing section 19 and the radiation port 41, the auxiliary stirring section 62 is placed upstream from the radiation pipe 40, and the stirring section 61 is placed downstream from the radiation pipe 40. Therefore, amounts of gas and liquid which separately flow in the radiation pipe 40 are small until they reach the stirring section 61. Hence, gas and liquid do not become foam, and it is possible to prevent intermittent radiation which is a phenomenon that the gas and the liquid do not become foam and they are radiated alternately. Since stirring performance of the auxiliary stirring section 62 is lower than that of the stirring section 61, the auxiliary stirring section 62 is made smaller than the stirring section 61, a space around the switching valve 50 can be saved, and the stirring section 61 located on the side of the radiation port 41 can integrally be formed with the radiation port 41.

Further, as the stirring operation of gas and liquid is progressed, fluid resistance is increased. Therefore, if the auxiliary stirring section 62 is used, pressure loss caused by resistance of the radiation pipe 40 is suppressed as compared with a case where the stirring section 61 having sufficient stirring performance is placed upstream from the radiation pipe 40. Hence, even if the radiation pipe 40 is made long, momentum of foam radiation is less prone to be deteriorated. Further, when an aspirator which does not use electric power but utilizes a pressure difference of water is used as the drug supply section 15, a force of supply of drug is easily secured even if the radiation pipe 40 is made long.

In the foam supply device of the first embodiment, the stirring section 61 is provided between the other end of the radiation pipe 40 and the radiation port 41. Therefore, it is possible to reduce not only resistance in the water pipe 13 but also resistance in the radiation pipe 40, and it is possible to stably radiate foam without deteriorating momentum of radiation.

When the switching valve 50 is fixed to the tap water pipe, since a force from the radiation pipe 40 is not applied directly to the chassis 10, it is unnecessary to strongly fix the chassis 10, and it is unnecessary to enhance the strength of the chassis 10.

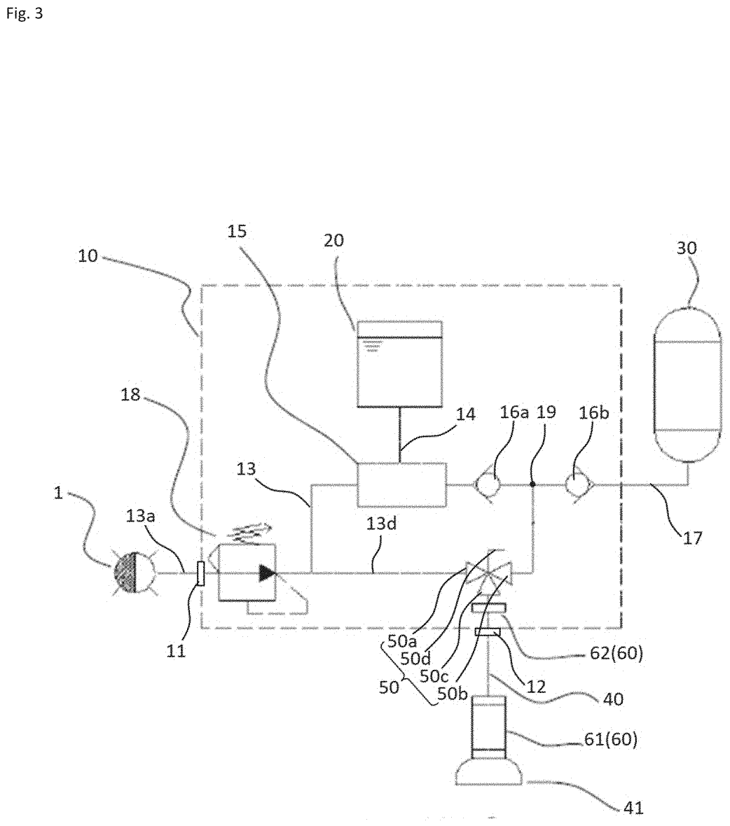

FIG. 3 is a piping system diagram of a foam supply device according to a second embodiment of the invention.

The same symbols are allocated to the same function members as those of the first embodiment, and differences from the first embodiment will be described below.

In the foam supply device of the second embodiment, a switching valve 50 and an auxiliary stirring section 62 are placed in a chassis 10. A water pipe 13d which is branched off from a water pipe 13 located on a downstream side of a water regulator 18 is connected to one introduction port 50a of the switching valve 50.

In the second embodiment, water mixed with drug and gas and stirred by the auxiliary stirring section 62 flows through the radiation pipe 40, and the radiation pipe 40 is connected to a water pipe discharge port 12.

According to the second embodiment, a volume of the chassis 10 is increased by a volume of the switching valve 50, but since the radiation pipe 40 is connected to the chassis 10, it is only necessary to install the chassis 10 and a gas supply section 30, and the installation becomes easy.

According to the foam supply device of the second embodiment, a stirring section 61 is placed downstream from the water pipe discharge port 12, and water which is not stirred by the stirring section 61 flows through a water pipe 13 placed in the chassis 10. Therefore, resistance in the water pipe 13 can be reduced in the chassis 10, it is possible to stably radiate foam without deteriorating momentum of radiation, and since the stirring section 61 is not placed in the chassis 10, the chassis 10 can be made small.

The foam supply device of the second embodiment includes the auxiliary stirring section 62 having stirring performance which is lower than that of the stirring section 61, the stirring section 61 and the auxiliary stirring section 62 are placed between the gas mixing section 19 and the radiation port 41, the auxiliary stirring section 62 is placed upstream from the radiation pipe 40, and the stirring section 61 is placed downstream from the radiation pipe 40. Therefore, since gas and liquid do not separately flow in the radiation pipe 40 until they reach the stirring section 61, it is possible to prevent intermittent radiation which is a phenomenon that the gas and the liquid do not become foam and they are radiated alternately. Further, since stirring performance of the auxiliary stirring section 62 is lower than that of the stirring section 61, the auxiliary stirring section 62 becomes smaller than the stirring section 61, a space around the switching valve 50 can be saved, and the stirring section 61 located on the side of the radiation port 41 can integrally be formed with the radiation port 41. Further, as the stirring operation of gas and liquid is progressed, fluid resistance is increased. Therefore, if the auxiliary stirring section 62 is used, pressure loss caused by resistance of the radiation pipe 40 is suppressed as compared with a case where the stirring section 61 having sufficient stirring performance is placed upstream from the radiation pipe 40. Hence, even if the radiation pipe 40 is made long, momentum of foam radiation is less prone to be deteriorated.

In the foam supply device of the second embodiment, the stirring section 61 is provided between the other end of the radiation pipe 40 and the radiation port 41. Therefore, it is possible to reduce not only resistance in the water pipe 13 but also resistance in the radiation pipe 40, and it is possible to stably radiate foam without deteriorating momentum of radiation.

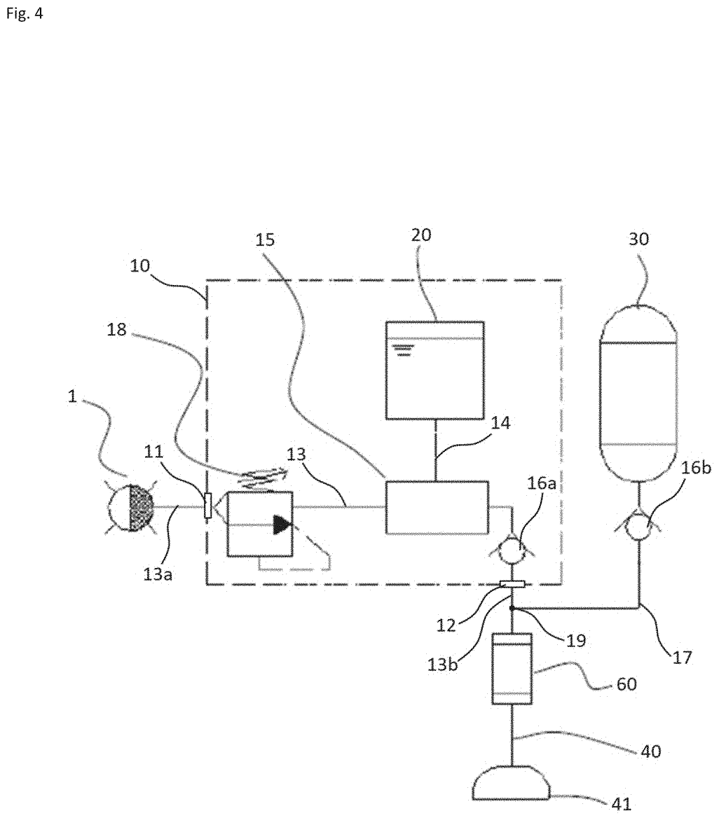

FIG. 4 is a piping system diagram of a foam supply device according to a third embodiment of the invention.

The same symbols are allocated to the same function members as those of the first embodiment, and differences from the first embodiment will be described below.

The foam supply device of the third embodiment do not include a switching valve 50 and an auxiliary stirring section 62.

In the foam supply device of the third embodiment, a stirring section 60 is placed downstream from the water pipe discharge port 12, and water which is not stirred by the stirring section 60 flows through a water pipe 13 placed in a chassis 10. Therefore, since water mixed with gas and drug is not stirred in the chassis 10, it is possible to eliminate a gain of resistance which is caused because foam becomes fine and a gain of fluid resistance which is caused because the stirring section 60 passes. Hence, it is possible to reduce the resistance in the water pipe 13, and foam can stably be radiated without deteriorating momentum of radiation. Since the stirring section 60 is not placed in the chassis 10, the chassis 10 can be made small.

Further, according to the foam supply device of the third embodiment, the gas mixing section 19 is placed downstream from the water pipe discharge port 12, and water which is not mixed with gas flows through the water pipe 13 placed in the chassis 10. Therefore, since gas is not mixed in the chassis 10, resistance in the water pipe 13 can be reduced, and foam can stably be radiated without deteriorating momentum of radiation. Since the stirring section 60 and the gas mixing section 19 are not placed in the chassis 10, the chassis 10 can be made small.

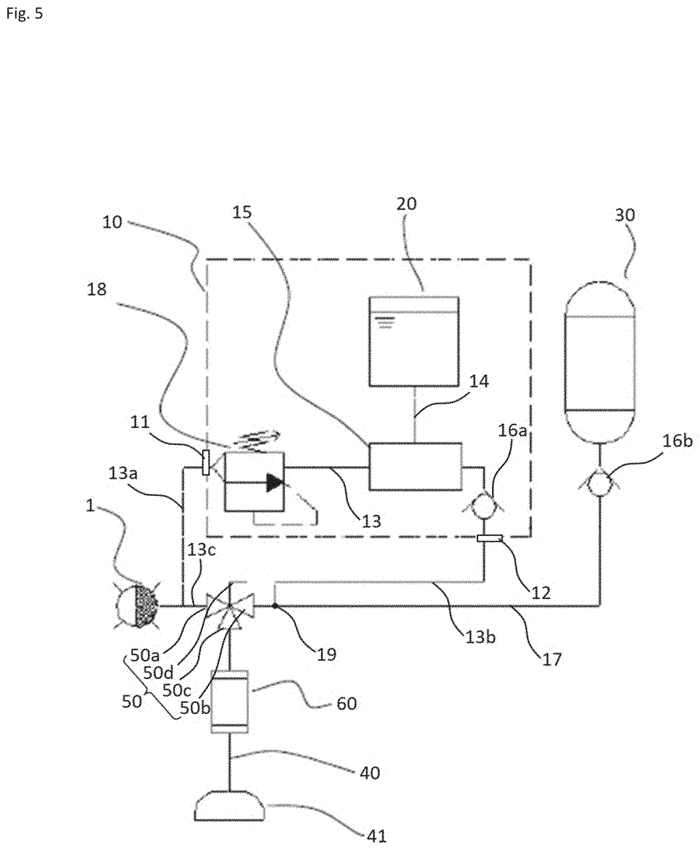

FIG. 5 is a piping system diagram of a foam supply device according to a fourth embodiment of the invention.

The same symbols are allocated to the same function members as those of the first embodiment, and differences from the first embodiment will be described below.

The foam supply device of the fourth embodiment do not include an auxiliary stirring section 62.

In the foam supply device of the fourth embodiment, a stirring section 60 is placed downstream from the water pipe discharge port 12, and water which is not stirred by the stirring section 60 flows through a water pipe 13 placed in a chassis 10. Therefore, since water mixed with gas and drug is not stirred in the chassis 10, it is possible to eliminate a gain of resistance which is caused because foam becomes fine and a gain of fluid resistance which is caused because the stirring section 60 passes. Hence, it is possible to reduce the resistance in the water pipe 13, and foam can stably be radiated without deteriorating momentum of radiation. Since the stirring section 60 is not placed in the chassis 10, the chassis 10 can be made small.

Further, according to the foam supply device of the fourth embodiment, the gas mixing section 19 is placed downstream from the water pipe discharge port 12, and water which is not mixed with gas flows through the water pipe 13 placed in the chassis 10. Therefore, since gas is not mixed in the chassis 10, resistance in the water pipe 13 can be reduced, and foam can stably be radiated without deteriorating momentum of radiation. Since the stirring section 60 and the gas mixing section 19 are not placed in the chassis 10, the chassis 10 can be made small.

In the foam supply device of the fourth embodiment, the switching valve 50 selectively switches between “water mixed with drug and gas” and “water which is not mixed with drug and gas”, and introduces the selectively switched one of them into the radiation pipe 40, the switching valve 50 is placed downstream from the water pipe discharge port 12, and the gas mixing section 19 is placed upstream from the switching valve 50. Therefore, water can be radiated and foam can be radiated through one radiation port 41 as required by a user, and since the switching valve 50 is not placed in the chassis 10, the chassis 10 can be made small.

When the switching valve 50 is fixed to the tap water pipe, since a force from the radiation pipe 40 is not applied directly to the chassis 10, it is unnecessary to strongly fix the chassis 10, and it is unnecessary to enhance the strength of the chassis 10.

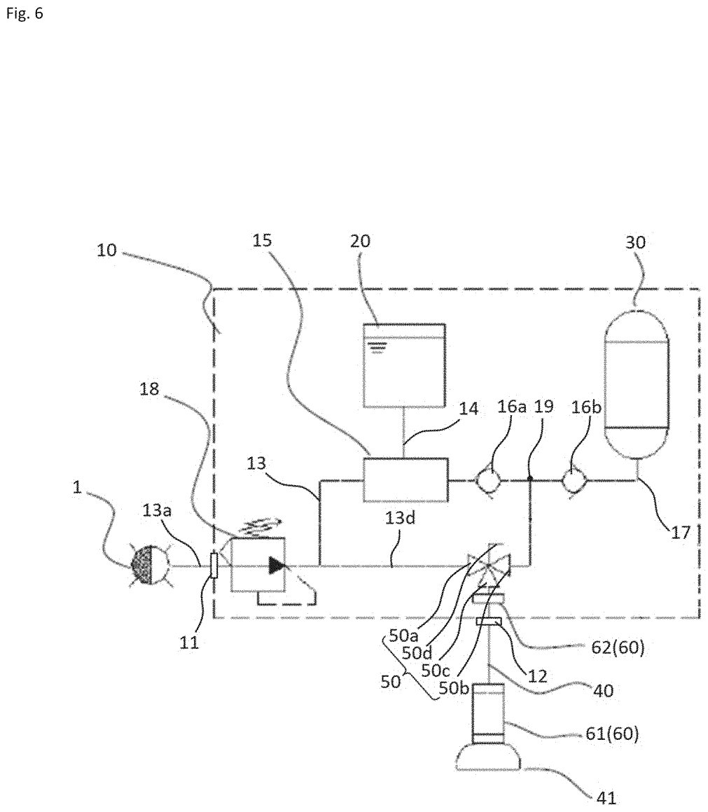

FIG. 6 is a piping system diagram of a foam supply device according to a fifth embodiment of the invention.

The same symbols are allocated to the same function members as those of the second embodiment, and differences from the second embodiment will be described below.

In the foam supply device of the fifth embodiment, a gas supply section 30 is placed in a chassis 10.

When a compressor is used as the gas supply section 30, since the compressor has a susceptibility to water-wettability and wet circumstances, it is preferable that the compressor is placed separately from the chassis 10, but if a pressure cylinder is used as the gas supply section 30 which is strong for water-wettability and wet circumstances, it may be placed in the chassis 10.

In the foam supply device of the fifth embodiment, a stirring section 61 is placed downstream from a water pipe discharge port 12, and water which is not stirred by the stirring section 61 flows through a water pipe 13 placed in the chassis 10. Therefore, in the chassis 10, resistance in the water pipe 13 can be reduced, foam can stably be radiated without deteriorating momentum of radiation, and since the stirring section 61 is not placed in the chassis 10, the chassis 10 can be made small.

The foam supply device of the fifth embodiment includes an auxiliary stirring section 62 having stirring performance which is lower than that of the stirring section 61, the stirring section 61 and the auxiliary stirring section 62 are placed between a gas mixing section 19 and a radiation port 41, the auxiliary stirring section 62 is placed upstream from a radiation pipe 40, and the stirring section 61 is placed downstream from the radiation pipe 40. Therefore, gas and liquid do not separately flow in the radiation pipe 40 until they reach the stirring section 61. Hence, gas and liquid do not become foam, and it is possible to prevent intermittent radiation which is a phenomenon that the gas and the liquid do not become foam and they are radiated alternately. Since stirring performance of the auxiliary stirring section 62 is lower than that of the stirring section 61, the auxiliary stirring section 62 is made smaller than the stirring section 61, a space around the switching valve 50 can be saved, and the stirring section 61 located on the side of the radiation port 41 can integrally be formed with the radiation port 41. Further, as the stirring operation of gas and liquid is progressed, fluid resistance is increased. Therefore, if the auxiliary stirring section 62 is used, pressure loss caused by resistance of the radiation pipe 40 is suppressed as compared with a case where the stirring section 61 having sufficient stirring performance is placed upstream from the radiation pipe 40. Hence, even if the radiation pipe 40 is made long, momentum of foam radiation is less prone to be deteriorated.

According to the foam supply device of the fifth embodiment, the stirring section 61 is provided between the other end of the radiation pipe 40 and the radiation port 41. Therefore, it is possible to reduce not only resistance in the water pipe 13 but also resistance in the radiation pipe 40, and it is possible to stably radiate foam without deteriorating momentum of radiation.

### INDUSTRIAL APPLICABILITY

According to the foam supply device of the present invention, it is possible to install a small chassis in a cleaning location such as a bathroom of a care facility and to continuously radiate cleaning foam from a shower head. Therefore, it is possible to enhance skin health of a user, a favorite pet and the like, and time, effort and labor of a foaming or bubbling operation of the user. Further, the invention can be utilized as a foam supply device for cleaning something by foam, and for cleaning dishes or vehicles by foam.

### EXPLANATION OF SYMBOLS

1 faucet
10 chassis
11 water supply port
12 water pipe discharge port
13 water pipe
13a introduction water pipe
13b deriving water pipe
13c water pipe
13d water pipe
14 drug supply pipe
15 drug supply section
16a water check valve
16b drug check valve
17 gas supply pipe
18 water regulator
19 gas mixing section
20 drug storage tank
30 gas supply section
40 radiation pipe
41 radiation port
50 switching valve
50a one introduction port
50b other introduction port
50c deriving port
50d lever
60 stirring section
61 stirring section
62 auxiliary stirring section

1: A foam supply device of the invention comprising:
a water supply port for supplying water from a water supply source;
a water pipe for introducing the water from the water supply port;
a drug supply pipe for supplying drug;
a drug supply section for connecting the drug supply pipe to the water pipe to supply the drug to the water;
a gas supply pipe for supplying gas from a gas supply section;
a gas mixing section for connecting the gas supply pipe to the water pipe to mix the gas in the water;
a stirring section for stirring the gas and the drug which is supplied to the water;
a water pipe discharge port for discharging the water mixed with at least the drug; and
a radiation pipe having one end connected to the water pipe discharge port and the other end connected to a radiation port which radiates the water, the drug and the gas stirred by the stirring section, in which
the chassis includes the water supply port and the water pipe discharge port,
the water pipe, the drug supply pipe and the drug supply section are placed in the chassis, wherein
the stirring section is placed downstream from the water pipe discharge port, and
the water which is not stirred by the stirring section flows through the water pipe placed in the chassis.

2: The foam supply device according to claim 1, wherein the gas mixing section is placed downstream from the water pipe discharge port, and the water which is not mixed with the gas flows through the water pipe placed in the chassis.

3: The foam supply device according to claim 2, further comprising a switching valve which selectively switches between the water mixed with the drug and the gas and the water which is not mixed with the drug and the gas, and introduces the selectively switched one of them into the radiation pipe, wherein the switching valve is placed downstream from the water pipe discharge port, and the gas mixing section is placed upstream from the switching valve.

4: The foam supply device according to claim 3, wherein the switching valve is fixed to the tap water pipe.

5: The foam supply device according to claim 1, further comprising an auxiliary stirring section having stirring performance which is lower than that of the stirring section, wherein the stirring section and the auxiliary stirring section are placed between the gas mixing section and the radiation port, and the auxiliary stirring section is placed upstream from the stirring section.

6: The foam supply device according to claim 1, wherein the stirring section is placed between the radiation port and the other end of the radiation pipe.
